(19) United States
(12) Patent Application Publication
(10) Pub. No.: US 2008/0139262 A1
(43) Pub. Date: Jun. 12, 2008

(54) Multiband frequency selective filter

(76) Inventor: Han-Ni Lin, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/783,621

(22) Filed: Apr. 11, 2007

(30) Foreign Application Priority Data
Dec. 8, 2006 (TW) 095221640

(51) Int. Cl. H04M 1/00

(52) U.S. Cl. 455/575.7

(57) ABSTRACT

A multiband frequency selective filter is assembled on a housing or an antenna module of a small portable device. The multiband frequency selective filter comprises at least two overlapped substrates. Each substrate includes a dielectric base and a conductive layer. The conductive layers respectively form unit cells. The unit cells are arrayed periodically or non-periodically. Appropriate shape and arrangement of the unit cells and overlapping of the substrates, forms a three-dimensional resonant array of inductance and capacitance in direction of a plane and height of the unit cells, thereby evidently lessening resonant wave length of electromagnetic wave and achieving miniature of unit cells of FSS.

### BACKGROUND OF THE INVENTION

1. Field of the Invention

The present invention relates to a frequency selective filter, and particularly to a multiband frequency selective filter which provides multi-layer resonators to decrease resonant wave length of electromagnetic waves, thereby minimizing unit cells of frequency selective surface (FSS).

2. Related Art

With development of wireless communication technology, mobile phones are used commonly as personal electronic products. Electromagnetic waves radiated by mobile phones usually bring electromagnetic interference to ambient electronic products, and even hurt users' brains. For portable wireless communication products, it is rather crucial to abate impact of electromagnetic interference (EMI) and specific absorption rate (SAR).

Frequency Selective Surface (FSS) is capable of filtering electromagnetic waves of particular frequency bands by means of Band Pass or Band Stop. The principle is size of a unit cell of FSS is approximately equal to wave length of electromagnetic waves to be processed. In other words, size of a unit cell of FSS is proportional to wave length of the electromagnetic wave. For instance, plane size of a mobile phone is generally about 45 mm×100 mm, while wave length of the electromagnetic wave is ranged of 140 mm to 350 mm (respectively corresponding to 3 G/2.1 GHz and GSM/850 MHz). Nowadays people are endeavored to develop application of FSS at these frequency bands. However, size of the unit cell is still excessively large. As a result, only electromagnetic wave of the frequency band can be shielded from a large device or building, but emission of electromagnetic wave in a small device can not be prevented. It is desired that FSS is applied to small devices, such as mobile phone, to lower impact of EMI and SAR. Correspondingly, how to decrease resonant wave length to minimize size of unit cells of FSS, becomes a critical issue.

### SUMMARY OF THE INVENTION

Accordingly, an object of the present invention is to provide a multiband frequency selective filter which is provided on a housing or an antenna module of a small portable device for permitting electromagnetic waves of communication frequency bands to pass and shielding electromagnetic waves out of range of communication frequency bands, and which effectively lowers EMI of electromagnetic waves to ambient and impact of SAR to users' brains.

The multiband frequency selective filter comprises at least two overlapped substrates. The present invention is characterized in:

Each substrate includes a dielectric base and a conductive layer. The conductive layers respectively form unit cells. The unit cells are arrayed periodically or non-periodically. Appropriate shape and arrangement of the unit cells and overlapping of the substrates, forms a three-dimension resonant array of inductance and capacitance in the direction of a plane and height of the unit cells, evidently lessening resonant wave length of electromagnetic waves and minimizing unit cells of FSS.

The dielectric base has an upper surface for assembling the conductive layer, and a lower surface for serving as an engaging surface for overlapping. Each unit cell of the FSS includes a central portion and a pair of side portions at opposite sides of the central portion. The central portion is shaped as two parallel lines of a cross therein, and the side portions are U-shaped.

The unit cells form appropriate gaps therebetween. The side portions and the central portion of each unit cell may be hollow loop.

The unit cells are arranged in a manner that the unit cells of a substrate are 90 degree with respect to unit cells of another substrate, forming symmetric structure, and thus influence of polarization and incident angles may be reduced.

The substrates may be assembled by means of adhesive or hot-pressing.

Patterning of the conductive layers and assembling of the conductive layers onto the dielectric bases, may be made by stamping, integrally shaping, adhesive, hot-press, ink-jet printing, screen printing, lithography etching like FPC, surface activation, or chemical plating.

### BRIEF DESCRIPTION OF THE DRAWINGS

FIG. 1 is an exploded view of a multiband frequency selective filter according to the present invention.

FIGS. 1A and 1B are partially enlarged views of unit cells of conductive layers of FIG. 1.

FIG. 2 is an assembled view of the multiband frequency selective filter of FIG. 1.

FIG. 3 is a cross-sectional view taken along the line 3-3 of FIG. 2.

FIG. 4 is an exploded view of the multiband frequency selective filter assembled on an inside of a housing of a mobile phone.

FIG. 5 is an exploded view of the multiband frequency selective filter assembled on an outside of a housing of a mobile phone.

FIG. 6 is an exploded view of the multiband frequency selective filter assembled on an antenna module.

FIG. 7 is a graph illustrating filtering results of the multiband frequency selective filter in practice.

### DESCRIPTION OF THE PREFERRED EMBODIMENTS

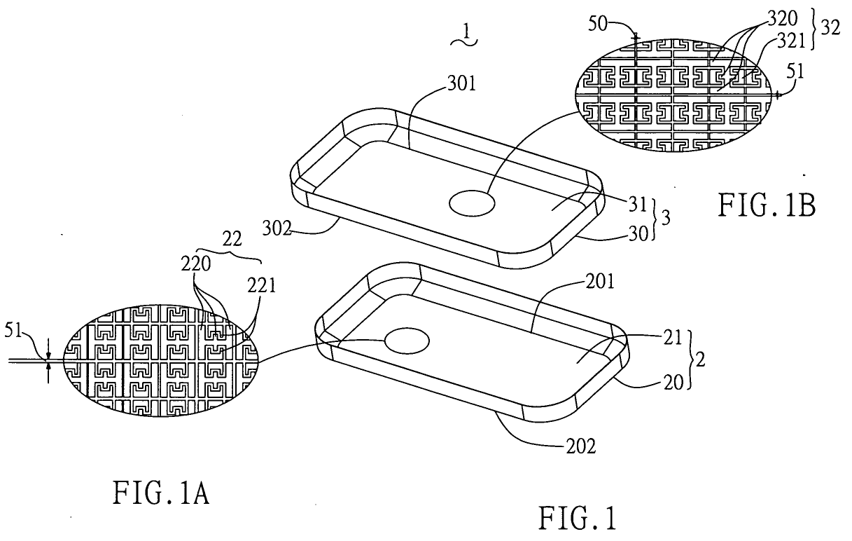

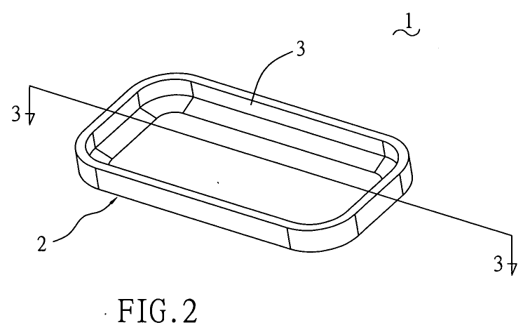

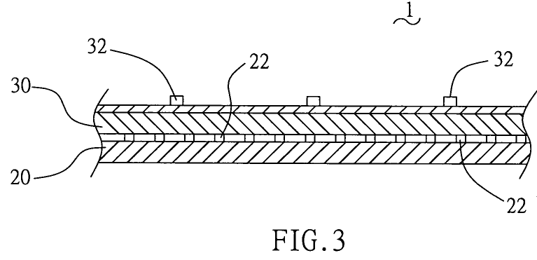

With reference to FIGS. 1 to 3, a multiband frequency selective filter 1 comprises a couple of overlapped substrates 2, 3. Each substrate 2/3 includes a dielectric base 20/30 and a conductive layer 21/31. The substrate 2, 3 may be assembled by means of adhesive or hot-pressing. The dielectric bases 20, 30 respectively have upper surfaces 201, 301 and lower surfaces 202, 302. The conductive layers 21, 31 are respectively assembled on the upper surfaces 201, 301. The lower surfaces 202, 302 respectively serve as engaging surfaces of overlapping. The conductive layers 21, 31 respectively form unit cells 22, 32. Each unit cell 22/32 includes a central portion 220/320 shaped as two parallel lines of a cross therein, and a pair of U-shaped side portions 221/321 on opposite sides of the central portion 220/320. The central portion 220/320 and the side portions 221/321 are periodically arrayed and spaced of equidistance, defining a rectangular grid. The U-shaped side portions 221/321 provide capacitive loading to the central portions 220/320. The unit cells 22/32 form appropriate gaps 50/51 therebetween. Patterning of the conductive layers 21, 31 and assembling of the conductive layers 21, 31 onto the dielectric bases 20, 30, may be formed by stamping, integrally shaping, adhesive, hot-press, ink-jet printing, screen printing, lithography etching like FPC, surface activation, or chemical plating etc. Moreover, the unit cells 22, 32 of the conductive layers 21, 31 are arranged in a manner that the unit cells 22 of the substrate 2 are 90 degree with respect to the unit cells 32 of the substrate 3, forming symmetric structure, as shown in FIGS. 1A and 1B. Thus influence of polarization and incident angles may be reduced. The appropriate shape and arrangement of the unit cells 22, 32 and overlapping of the substrates 2, 3, forms a three-dimensional resonant array of inductance and capacitance in direction of a plane and height of the unit cells 22, 32, evidently lessening resonant wave length of electromagnetic wave, and obtaining miniature of unit cells of FSS. Therefore, the present invention is adapted to small devices, for example mobile phone. The resonant array provides multi-layer filtering, selectively allowing electromagnetic waves within communication frequency bands to pass, and shielding electromagnetic waves out of communication frequency bands, thereby effectively reducing impact of EMI and SAR.

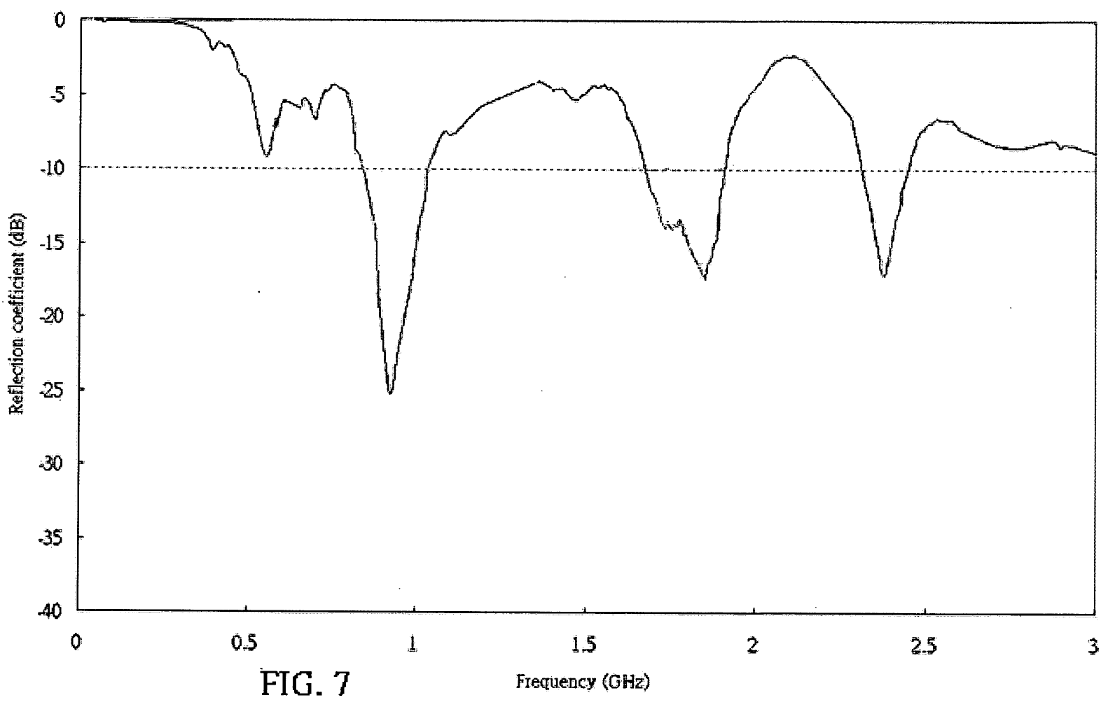

FIG. 7 illustrates filtering results of the multiband frequency selective filter in practice. In FIG. 7, the transverse axis represents frequency, and the longitudinal axis represents reflection coefficient. It is explicitly appreciated that electromagnetic waves in frequency bands of GSM 900/1800 MHz and WLAN 2.4 GHz are selectively allowed to pass. Change of size of the unit cells 22, 32 and the gaps 50, 51, and varying of material and thickness of the dielectric bases 20, 30 and the conductive layers 21, 31, may adjust resonant frequency and frequency band width to other frequency bands.

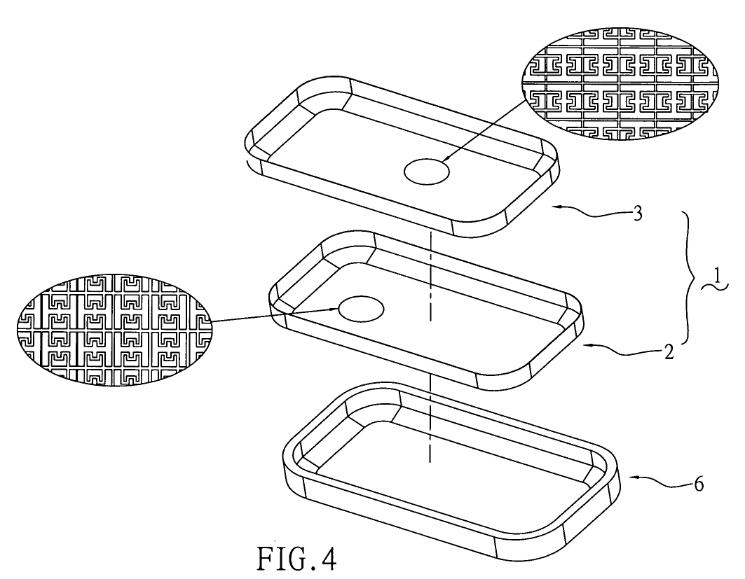

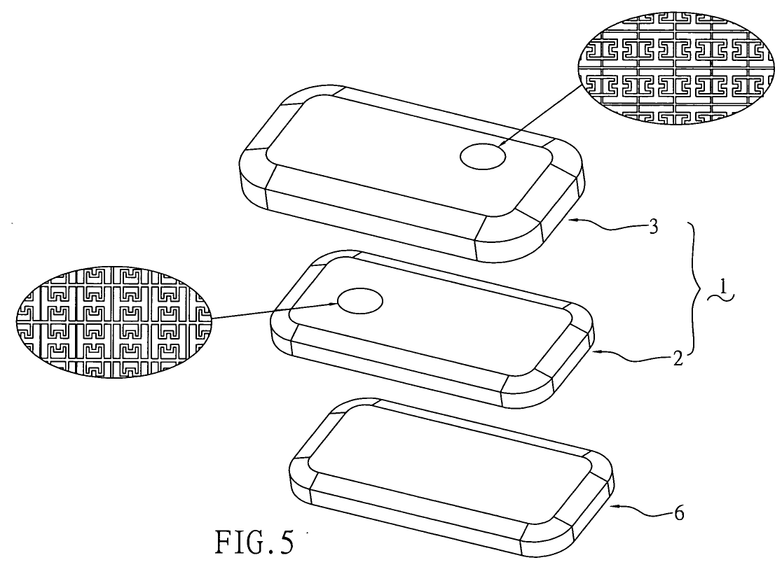

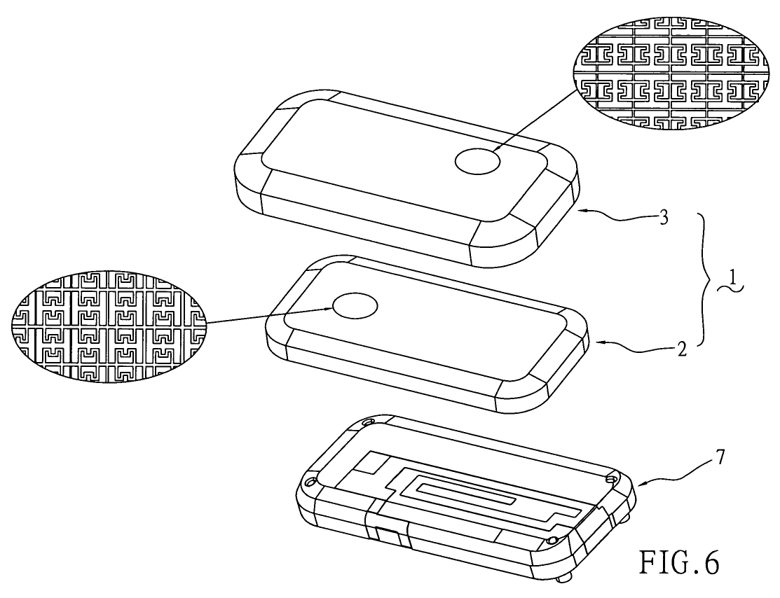

FIGS. 4 to 6 show an application example of the multiband frequency selective filter 1. FIG. 4 is an exploded view of the multiband frequency selective filter assembled on an inside of a housing of a mobile phone. FIG. 5 is an exploded view of the multiband frequency selective filter assembled on an outside of a housing of a mobile phone. FIG. 6 is an exploded view of the multiband frequency selective filter assembled on an antenna module 7 of a mobile phone. Electromagnetic waves in communication frequency bands are selectively allowed to pass, and electromagnetic waves out of communication frequency bands are shielded, effectively reducing EMI of electromagnetic wave to ambient and impact of SAR to users' brains.

Besides the described above, the multiband frequency selective filter 1 may be employed in other applications.

(1) The present invention may be applied as multi-layer resonators for shortening resonant wave length and selectively filtering in multiple frequency bands. The following requirements may be used alone or be combined together for adjusting application frequency bands and frequency width.

1. more than two layers of substrates.

2. Material and thickness of a dielectric base and a conductive layer of each substrate may be the same or different.

3. Size and shape of unit cells of the conductive layer may be decorated or changed, and each substrate may have combination of the same unit cells or different unit cells.

4. The unit cells of the conductive layer may be arrayed in other ways.

(2) Each unit cell of the conductive layer includes a central portion and a pair of side portions at opposite sides thereof. The side portions may be symmetric or asymmetric. The side portions form capacity loading to the central portion. Shape of the side portions and the central portion is not limited in U-shape and in two parallel lines of a cross therein.

(3) The unit cells of the conductive layers may be hollow loop, and are not limited in solid shape as described above.

The foregoing is provided for illustrative purposes only. Modifications and adaptations to the described embodiments may be made without departing from the scope or spirit of the invention. Other aspects, features and advantages will be apparent upon an examination of the attached drawing Figures and appended claims.

1. A multiband frequency selective filter comprising at least two overlapped substrates, wherein
each substrate includes a dielectric base and a conductive layer, the dielectric base having an upper surface for assembling the conductive layer, and a lower surface for serving as an engaging surface for overlapping, the conductive layers respectively forming unit cells, the unit cells being arrayed periodically, appropriate shape and arrangement of the unit cells and overlapping of the substrates forming a three-dimensional resonant array of inductance and capacitance in direction of a plane and height of the unit cells, thereby evidently lessening resonant wave length of electromagnetic wave and minimizing unit cells of FSS.

2. The multiband frequency selective filter as claimed in claim 1, wherein the unit cells form appropriate gaps therebetween.

3. The multiband frequency selective filter as claimed in claim 2, wherein each unit cell includes a central portion and side portions at opposite sides of the central portion.

4. The multiband frequency selective filter as claimed in claim 3, wherein the central portion is shaped as two parallel lines of a cross therein, and the side portions are U-shaped.

5. The multiband frequency selective filter as claimed in claim 1, wherein the unit cells are arranged in a manner that the unit cells of one substrate are 90 degree with respect to the unit cells of another substrate to form symmetric structure, thus influence of polarization and an incident angle being reduced.

6. The multiband frequency selective filter as claimed in claim 3, wherein the side portions and the central portion may be hollow loop.

7. The multiband frequency selective filter as claimed in claim 1, wherein the substrates may be assembled by means of adhesive or hot-pressing.

8. The multiband frequency selective filter as claimed in claim 1, wherein patterning of the conductive layers and assembling of the conductive layers onto the dielectric bases, may be made by stamping, integrally shaping, adhesive, hot-press, ink-jet printing, screen printing, lithography etching like FPC, surface activation, or chemical plating.

9. The multiband frequency selective filter as claimed in claim 1, wherein the dielectric bases and the conductive layers of the substrates may be of the same or different material and thickness.

10. The multiband frequency selective filter as claimed in claim 1, wherein the substrates may have combination of the same unit cells or different unit cells.

11. The multiband frequency selective filter as claimed in claim 1, wherein the overlapped substrates may be assembled on an inside of a housing of a mobile phone, an outside of a housing of a mobile phone, or an antenna module.

12. The multiband frequency selective filter as claimed in claim 1, wherein the unit cells are arrayed unperiodically.
